(19) United States
(12) Patent Application Publication
(10) Pub. No.: US 2006/0187376 A1
(43) Pub. Date: Aug. 24, 2006

(54) BACKLIGHT MODULE AND LIQUID CRYSTAL DISPLAY MODULE

(76) Inventors: Yun-Shih Wang, Taoyuan County (TW); Kuo-Liang Chu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,498

(22) Filed: Feb. 23, 2005

(51) Int. Cl. G02F 1/1335

(52) U.S. Cl. 349/62

(57) ABSTRACT

A backlight module including a frame, a light guide, at least one reflective cover and at least one light source is provided. The frame includes an upper frame having at least one first fastener thereon and a lower frame having at least one second fastener thereon. The light guide is disposed inside the frame and has at least one light incident surface and a light emitting surface. The reflective cover is placed inside the frame at one side of the frame. The reflective cover has at least one third fastener and at least one fourth fastener thereon, wherein the third fastener and the first fastener of the upper frame are fastened together while the fourth fastener and the second fastener of the lower frame are fastened together. The light source is disposed between the light incident surface of the light guide and the reflective cover.

### BACKGROUND OF THE INVENTION

1. Field of the Invention

The present invention generally relates to a backlight module and a liquid crystal display module. More particularly, the present invention relates to a backlight module capable of firmly fixing a reflective cover inside a frame and a liquid crystal display module using the same.

2. Description of Related Art

With recent advancement in opto-electronic fabricating techniques and the maturity of semiconductor manufacturing processes, the development of flat panel display devices, such as liquid crystal displays, organic light emitting diode displays and plasma displays, have proceeded quite rapidly. Usually, liquid crystal displays are applied to cell phones, digital cameras, digital video cameras, notebooks and personal computers. In a liquid crystal display, a backlight module is required to supply a surface light source to a liquid crystal display panel so that images are displayed on the liquid crystal display panel.

FIG. 1 is a drawing showing a conventional liquid crystal display module. FIG. 2 is a cross-sectional view showing a frame and a reflective cover of a conventional backlight module. As shown in FIG. 1 and FIG. 2, a liquid crystal display module 100 is constituted of a liquid crystal display panel 110 and a backlight module 120. The backlight module 120 includes a light guide 122, a reflective cover 124, a light source 126 and a frame 130. The frame 130 is composed of an upper frame 132 and a lower frame 134. The light guide 122 is placed inside the frame 130 and has a light incident surface 122a and a light emitting surface 122b. The reflective cover 124 is disposed inside the frame 130 and at one side of the frame 130.

As shown in FIG. 1, the light source 126 is disposed between the light incident surface 122a of the light guide 122 and the reflective cover 124. In addition, the liquid crystal display panel 110 is placed over the light emitting surface 122b of the light guide 122. Light from the light source 126 enters into the light guide 122 through the light incident surface 122a and forms a surface light source when emitting out the light guide 122 from the light emitting surface 122b, and then the surface light source is transmitted into the liquid crystal display panel 110. Besides, several optical films are further disposed between the light emitting surface 122b of the light guide and the liquid crystal display panel 110.

As shown in FIG. 2, the reflective cover 124 is sandwiched between the upper frame 132 and the lower frame 134 so as to firmly position the reflective cover 124. However, no fixture element is designed on the upper and lower frames 132, 134 and the reflective cover 124. The reflective cover 124 is merely sandwiched between the upper frame 132 and the lower frame 134 so that the reflective cover 124 may slant or shift when the backlight module 120 or the liquid crystal display module 100 is impacted by external force. If the reflective cover 124 slants or shifts inside the frame 130, several optical properties, such as surface light source brightness, light source utilization and the like, may deteriorate, so that the display quality of the liquid crystal display module 100 is also deteriorated.

### SUMMARY OF THE INVENTION

Accordingly, the present invention is directed to a backlight module capable of reducing deterioration of surface light source brightness and improving light source utilization.

The present invention is directed to a liquid crystal display module in which the backlight module has good surface light source brightness and light source utilization so as to maintain display quality of the liquid crystal display module.

According to an embodiment of the present invention, a backlight module comprising a frame, a light guide, at least one reflective cover and at least one light source is provided. The frame includes an upper frame having at least one first fastener thereon and a lower frame having at least one second fastener thereon. The light guide is disposed inside the frame and has at least one light incident surface and a light emitting surface. The reflective cover is placed inside the frame at one side of the frame. The reflective cover has at least one third fastener and at least one fourth fastener thereon, wherein the third fastener and the first fastener of the upper frame are fastened together while the fourth fastener and the second fastener of the lower frame are fastened together. The light source is disposed between the light incident surface of the light guide and the reflective cover.

According to an embodiment of the present invention, the light source and the reflective cover are disposed at one side of the frame so that the backlight module forms a single-edge type backlight module. According to another embodiment of the present invention, the light source and the reflective cover are disposed at a plurality of the sides of the frame so that the backlight module forms a multi-edge type backlight module.

According to an embodiment of the present invention, the first fastener may be a hole, a recession or a protrusion. The second fastener may be a hole, a recession or a protrusion. The third fastener may be a hole, a recession or a protrusion. The fourth fastener may be a hole, a recession or a protrusion.

According to an embodiment of the present invention, the backlight module further comprises at least one optical film disposed over the light emitting surface of the light guide. In addition, the light source is constituted of cold cathode fluorescent lamps or light emitting diodes.

According to an embodiment of the present invention, a liquid crystal display module comprising a backlight module and a liquid crystal display panel is provided. The backlight module includes a frame, a light guide, at least one reflective cover and at least one light source. The frame includes an upper frame having at least one first fastener thereon and a lower frame having at least one second fastener thereon. The light guide is disposed inside the frame and has at least one light incident surface and a light emitting surface. The reflective cover is placed inside the frame at one side of the frame. The reflective cover has at least one third fastener and at least one fourth fastener thereon, wherein the third fastener and the first fastener of the upper frame are fastened together while the fourth fastener and the second fastener of the lower frame are fastened together. The light source is disposed between the light incident surface of the light guide and the reflective cover. In addition, the liquid crystal display panel is disposed over the light emitting surface of the light guide.

According to an embodiment of the present invention, the light source and the reflective cover are disposed at one side of the frame so that the backlight module forms a single-edge type backlight module. According to another embodiment of the present invention, the light source and the reflective cover are disposed at a plurality of the sides of the frame so that the backlight module forms a multi-edge type backlight module.

According to an embodiment of the present invention, the first fastener may be a hole, a recession or a protrusion. The second fastener may be a hole, a recession or a protrusion. The third fastener may be a hole, a recession or a protrusion. The fourth fastener may be a hole, a recession or a protrusion.

According to an embodiment of the present invention, the backlight module further comprises at least one optical film disposed between the light emitting surface of the light guide and the liquid crystal display panel. In addition, the light source is constituted of cold cathode fluorescent lamps or light emitting diodes.

In the present invention, the upper frame and the lower frame of the backlight module have first and second fasteners thereon and the reflective cover has third and fourth fasteners thereon so that the reflective cover can be firmly fixed between the upper frame and the lower frame. Hence, surface light source brightness and light source utilization of the backlight module is not deteriorated even if the backlight module or the liquid crystal display module is impacted by any external force so that the liquid crystal display module has good display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing showing a conventional liquid crystal display module.

FIG. 2 is a cross-section view showing a frame and a reflective cover of a conventional backlight module.

FIG. 3 is a drawing showing a liquid crystal display module according to an embodiment of the present invention.

FIG. 4A is a cross-sectional view showing a reflective cover having protrusions thereon assembled to a frame having holes thereon according to a first embodiment of the present invention.

FIG. 4B is a cross-sectional view showing a reflective cover having protrusions thereon assembled to a frame having recessions thereon according to a second embodiment of the present invention.

FIG. 4C is a cross-sectional view showing a reflective cover having recessions thereon assembled to a frame having protrusions thereon according to a third embodiment of the present invention.

FIG. 4D is a cross-sectional view showing a reflective cover having holes thereon assembled to a frame having protrusions thereon according to a fourth embodiment of the present invention.

FIGS. 5A˜5L are cross-sectional views showing various fasteners on the frame and the reflective cover according to other embodiments of the present invention.

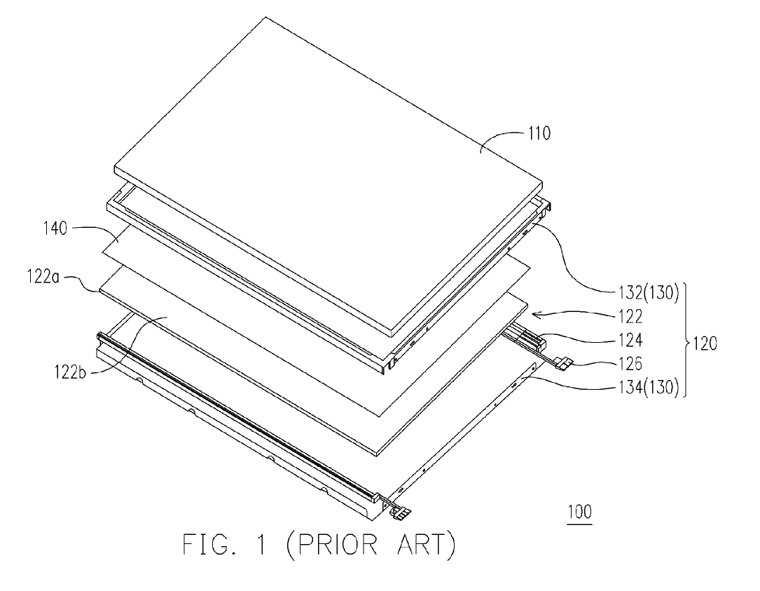

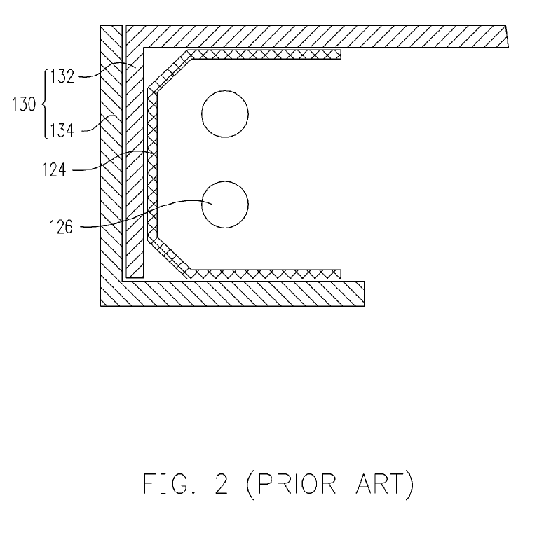

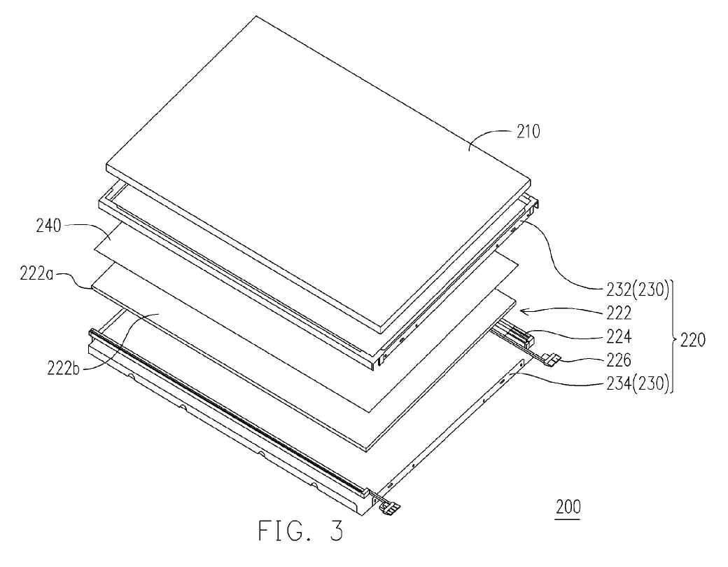

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

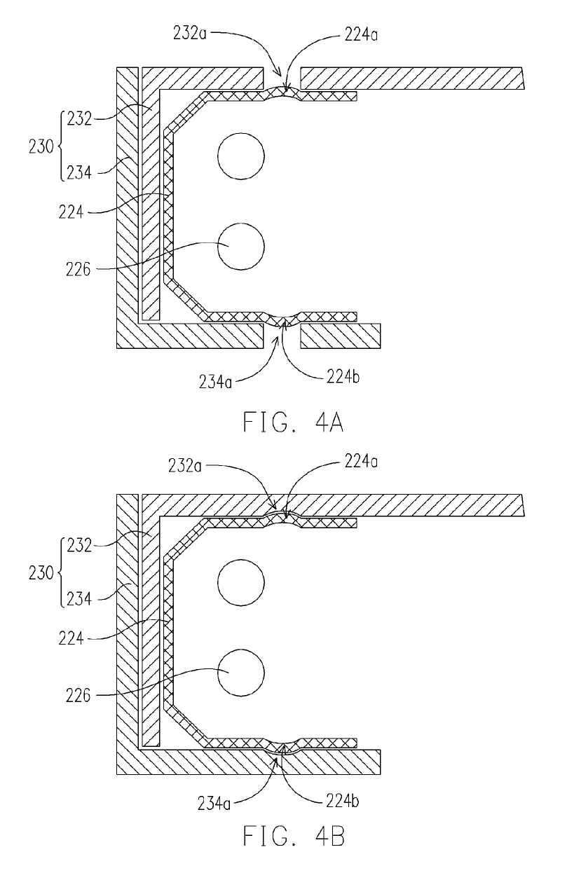

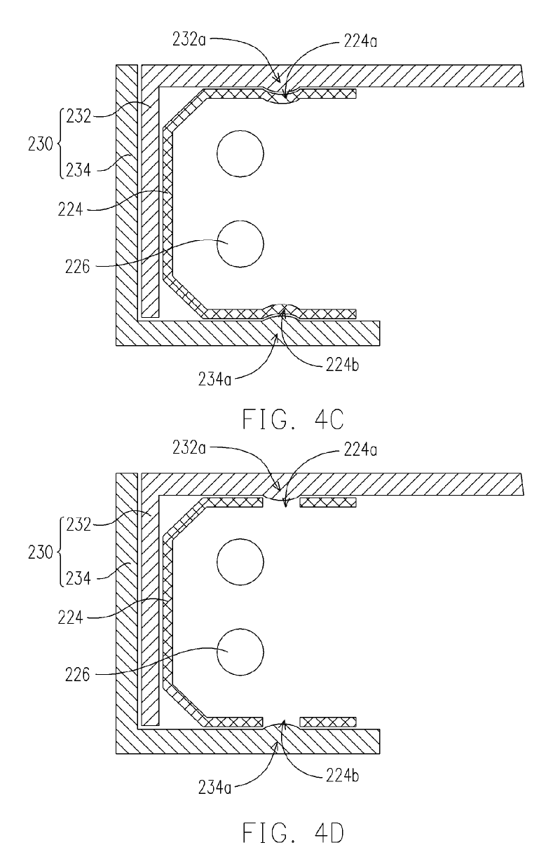

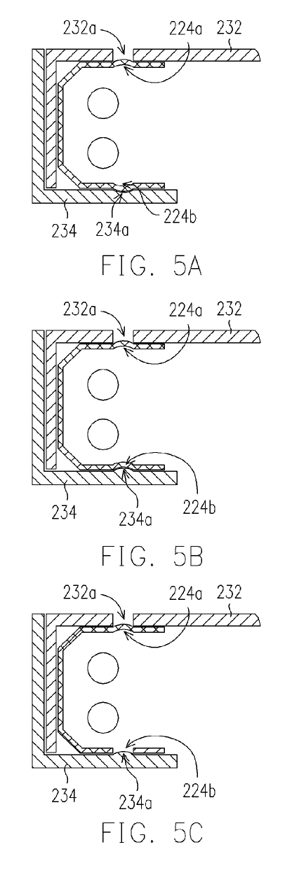

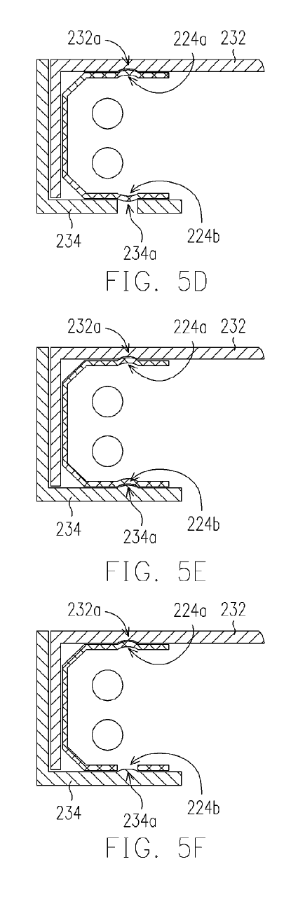

FIG. 3 is a drawing showing a liquid crystal display module according to an embodiment of the present invention. FIG. 4A is a cross-sectional view showing a reflective cover having protrusions thereon assembled to a frame having holes thereon according to a first embodiment of the present invention. As shown in FIG. 3 and FIG. 4A, a liquid crystal display module 200 is constituted of a liquid crystal display panel 210 and a backlight module 220. The backlight module 220 includes a frame 230, a light guide 222, at least one reflective cover 224 and at least one light source 226. The frame 230 is composed of a upper frame 232 having at least one first fastener 232a thereon and a lower frame 234 having at least one second fasteners 234a. For example, if the first fasteners 232a comprise one or more holes, the second fasteners 234a also correspondingly comprise one or more holes. Furthermore, the reflective cover 224 has at least one third fastener 224a and at least one fourth fastener 224b. The third and fourth fasteners 224a, 224b comprise protrusions, for example.

The third fastener 224a and the fourth fastener 224b are respectively correspond to the first fastener 232a of the upper frame 232 and the second fastener 234a of the lower frame 234. In other words, the third fastener 224a (protrusion) and the first fastener 232a (hole) of the upper frame 232 are fastened together while the fourth fastener 224b (protrusion) and the second fastener 234a (hole) of the lower frame 234 are fastened together by structurally engaging with each other when the reflective cover 224 and the frame 230 are assembled together. Hence, the reflective cover 224 can be firmly fixed between the upper and lower frame 232, 234 through the third/fourth fastener 224a/224b and the first/second fastener 232a/234a. Even if the backlight module 220 or the liquid crystal display module 200 is impacted by external force, the reflective cover 224 does not slant or shift easily.

As shown in FIG. 3, the light guide 222 is disposed inside the frame 230 and has at least one light incident surface 222a and a light emitting surface 222b. The liquid crystal display module 200 further comprises at least one optical film 240 disposed over the light emitting surface 222b of the light guide 222. The optical film 240 may include a diffusion film, a collection film and the like, for example. The light source 226 is disposed between the light incident surface 222a of the light guide 222 and the reflective cover 224. The light source 226 is constituted of cold cathode fluorescent lamps or light emitting diodes, for example. The liquid crystal display panel 210 is placed over the light emitting surface 222b of the light guide 222. Light emitted from the light source 226 enters into the light guide 222 through the light incident surface 222a and forms a surface light source when emitting out of the light guide 222 from the light emitting surface 222b, and then the surface light source is transmitted into the liquid crystal display panel 210.

In particular, the backlight module 220 of the liquid crystal display module 200 may be a single-edge type backlight module or a multi-edge type backlight module. If the backlight module 220 is a single-edge type backlight module, the light source 226 and the reflective cover 224 are disposed at one side of the frame 230. If the backlight module 220 is a multi-edge type backlight module, the light source 226 and the reflective cover 224 are disposed at a plurality of sides, such as two sides or four sides, of the frame 230.

It should be noted the first fastener 232a of the upper frame 232 and the second fastener 234a of the lower frame 234 and the third and fourth fasteners 224a, 224b of the reflective cover 224 have various modification and combination different from the first embodiment of FIG. 4A. For example, FIG. 4B is a cross-sectional view showing a reflective cover having protrusions thereon assembled to a frame having recessions thereon according to a second embodiment of the present invention. FIG. 4C is a cross-sectional view showing a reflective cover having recessions thereon assembled to a frame having protrusions thereon according to a third embodiment of the present invention. FIG. 4D is a cross-sectional view showing a reflective cover having holes thereon assembled to a frame having protrusions thereon according to a fourth embodiment of the present invention.

In FIG. 4B, the first fastener 232a of the upper frame 232 and the second fastener 234a of the lower frame 234 comprise holes while the corresponding third and fourth fasteners 224a, 224b of the reflective cover 224 comprise protrusions. As shown in FIG. 4C, the first fastener 232a of the upper frame 232 and the second fastener 234a of the lower frame 234 comprise protrusions while the corresponding third and fourth fasteners 224a, 224b of the reflective cover 224 comprise recessions. As shown in FIG. 4D, the first fastener 232a of the upper frame 232 and the second fastener 234a of the lower frame 234 comprise protrusions while the corresponding third and fourth fasteners 224a, 224b of the reflective cover 224 comprise holes.

As mentioned above, the first fastener 232a of the upper frame 232 and the second fastener 234a of the lower frame 234 may comprise holes, recessions or protrusions. The third and fourth fasteners 224a, 224b of the reflective cover 224 may also comprise holes, recessions or protrusions correspondingly so that the reflective cover 224 can be firmly fixed between the upper frame 232 and the lower frame 234. For example, when the third fastener 224a of the reflective cover 224 comprises protrusion, the corresponding first fastener 232a of the upper frame 232 may comprise a hole or a recession. Similarly, when the third fastener 224a of the reflective cover 224 comprises recession, the corresponding first fastener 232a of the upper frame 232 may comprise a protrusion. When the third fastener 224a of the reflective cover 224 comprises hole, the corresponding first fastener 232a of the upper frame 232 may comprise a protrusion. The fourth fastener 224b and the corresponding second fastener 234a may also comprise similar arrangement as described with reference to third fastener 224a and the first fastener 232a.

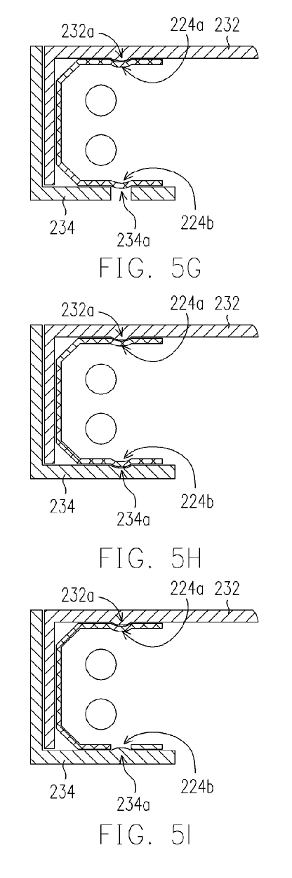

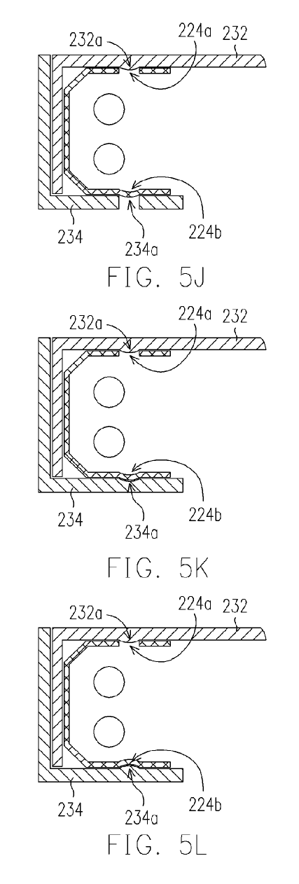

FIGS. 5A˜5L are cross-sectional views showing various fasteners on the frame and the reflective cover according to other embodiments of the present invention. As shown in FIG. 5A, the first fastener 232a of the upper frame 232 comprises a hole and the second fastener 234a of the lower frame 234 comprises a recession while the third and fourth fasteners 224a, 224b comprise protrusions correspondingly. As shown in FIG. 5B, the first fastener 232a of the upper frame 232 comprises a hole and the second fastener 234a of the lower frame 234 comprises a protrusion while the third fastener 224a comprises a protrusion and the fourth fastener 224b comprises a recession correspondingly.

As shown in FIG. 5C, the first fastener 232a of the upper frame 232 comprises a hole and the second fastener 234a of the lower frame 234 comprises a protrusion while the third fastener 224a comprises a protrusion and the fourth fastener 224b comprises a hole correspondingly. As shown in FIG. 5D, the first fastener 232a of the upper frame 232 comprises a recession and the second fastener 234a of the lower frame 234 comprises a hole while the third fastener 224a comprises a protrusion and the fourth fastener 224b comprises a protrusion correspondingly. As shown in FIG. 5E, the first fastener 232a of the upper frame 232 comprises a recession and the second fastener 234a of the lower frame 234 comprises a protrusion while the third fastener 224a comprises a protrusion and the fourth fastener 224b comprises a recession correspondingly.

As shown in FIG. 5F, the first fastener 232a of the upper frame 232 comprises a recession and the second fastener 234a of the lower frame 234 comprises a protrusion while the third fastener 224a comprises a protrusion and the fourth fastener 224b comprises a hole correspondingly. As shown in FIG. 5G, the first fastener 232a of the upper frame 232 comprises a protrusion and the second fastener 234a of the lower frame 234 comprises a hole while the third fastener 224a comprises a recession and the fourth fastener 224b comprises a protrusion correspondingly. As shown in FIG. 5H, the first fastener 232a of the upper frame 232 comprises a protrusion and the second fastener 234a of the lower frame 234 comprises a recession while the third fastener 224a comprises a recession and the fourth fastener 224b comprises a protrusion correspondingly.

As shown in FIG. 5I, the first fastener 232a of the upper frame 232 comprises a protrusion and the second fastener 234a of the lower frame 234 comprises a protrusion while the third fastener 224a comprises a recession and the fourth fastener 224b comprises a hole correspondingly. As shown in FIG. 5J, the first fastener 232a of the upper frame 232 comprises a protrusion and the second fastener 234a of the lower frame 234 comprises a hole while the third fastener 224a comprises a hole and the fourth fastener 224b comprises a protrusion correspondingly. As shown in FIG. 5K, the first fastener 232a of the upper frame 232 comprises a protrusion and the second fastener 234a of the lower frame 234 comprises a recession while the third fastener 224a comprises a hole and the fourth fastener 224b comprises a protrusion correspondingly. As shown in FIG. 5L, the first fastener 232a of the upper frame 232 comprises a protrusion and the second fastener 234a of the lower frame 234 comprises a protrusion while the third fastener 224a is a hole and the fourth fastener 224b comprises a recession correspondingly.

It should be noted that the first fastener 232a of the upper frame 232 and the second fastener 234a of the lower frame 234 and the third and fourth fasteners 224a, 224b of the reflective cover 224 are not limited to the above embodiments. Other modified fasteners may also be applied to the upper and lower frame 232, 234 and the reflective cover 224. Since the upper and lower frame 232, 234 and the reflective cover 224 have the fasteners thereon, the reflective cover 224 can be firmly fixed between the upper frame 232 and the lower frame 234. Even if the backlight module 220 or the liquid crystal display module 200 is impacted by external force, the reflective cover 224 does not slant or shift. Therefore, the deterioration of the surface light source brightness can be effectively reduced and light source of the backlight module 220 can be fully utilized so that the liquid crystal display module 200 has good display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a frame, comprising an upper frame and a lower frame, wherein the upper frame comprises at least one first fastener thereon while the lower frame comprises at least one second fastener thereon;
a light guide, disposed inside the frame, wherein the light guide comprises at least one light incident surface and a light emitting surface;
at least one reflective cover, disposed inside the frame at one side of the frame, wherein the reflective cover comprises at least one third fastener and at least one fourth fastener, and the third fastener and the first fastener are fastened together while the fourth fastener and the second fastener are fastened together; and
at least one light source, disposed between the light incident surface of the light guide and the reflective cover.

2. The backlight module according to claim 1, wherein the light source and the reflective cover are disposed at one side of the frame.

3. The backlight module according to claim 1, wherein the light source and the reflective cover are disposed at a plurality of the sides of the frame.

4. The backlight module according to claim 1, wherein the first fastener comprises a hole, a recession or a protrusion.

5. The backlight module according to claim 1, wherein the second fastener comprises a hole, a recession or a protrusion.

6. The backlight module according to claim 1, wherein the third fastener comprises a hole, a recession or a protrusion.

7. The backlight module according to claim 1, wherein the fourth fastener comprises a hole, a recession or a protrusion.

8. The backlight module according to claim 1, further comprising at least one optical film, disposed over the light emitting surface of the light guide.

9. The backlight module according to claim 1, wherein the light source is constituted of cold cathode fluorescent lamps or light emitting diodes.

10. A liquid crystal display module, comprising:
a backlight module, comprising:
a frame, comprising a upper frame and a lower frame, wherein the upper frame has at least one first fastener thereon while the lower frame has at least one second fastener thereon;
a light guide, disposed inside the frame, wherein the light guide comprises at least one light incident surface and a light emitting surface;
at least one reflective cover, disposed inside the frame at one side of the frame, wherein the reflective cover comprises at least one third fastener and at least one fourth fastener, and the third fastener and the first fastener are fastened together while the fourth fastener and the second fastener are fastened together;
at least one light source, disposed between the light incident surface of the light guide and the reflective cover; and
a liquid crystal display panel, placed over the light emitting surface of the light guide.

11. The liquid crystal display module according to claim 10, wherein the light source and the reflective cover are disposed at one side of the frame.

12. The liquid crystal display module according to claim 10, wherein the light source and the reflective cover are disposed at a plurality of the sides of the frame.

13. The liquid crystal display module according to claim 10, wherein the first fastener comprises a hole, a recession or a protrusion.

14. The liquid crystal display module according to claim 10, wherein the second fastener is a hole, a recession or a protrusion.

15. The liquid crystal display module according to claim 10, wherein the third fastener comprises a hole, a recession or a protrusion.

16. The liquid crystal display module according to claim 10, wherein the fourth fastener comprises a hole, a recession or a protrusion.

17. The liquid crystal display module according to claim 10, further comprising at least one optical film, disposed between the light emitting surface of the light guide and the liquid crystal display panel.

18. The liquid crystal display module according to claim 10, wherein the light source is constituted of cold cathode fluorescent lamps or light emitting diodes.
